(19) United States
(12) Patent Application Publication
(10) Pub. No.: US 2026/0220477 A1
(43) Pub. Date: Jul. 30, 2026

(54) DEVICE PARAMETER OPTIMIZATION

(71) Applicant: Mellanox Technologies, Ltd., Yokneam (IL)

(72) Inventors: Gil Shabat, Hod Hasharon (IL); Hanan Shteingart, Herzliya (IL); Chen Avin, Beer Sheva (IL); Roai Yadgar, Raanana (IL); Shie Mannor, Haifa (IL); Shai Malin, Tel Aviv (IL); Itay Alroy, Nes Ziona (IL)

(21) Appl. No.: 19/193,144

(22) Filed: Apr. 29, 2025

Related U.S. Application Data
(60) Provisional application No. 63/751,169, filed on Jan. 29, 2025.

(51) Int. Cl. G06N 3/092

(52) U.S. Cl. CPC G06N 3/092

(57) ABSTRACT

Apparatuses, systems, processors, and techniques to select values of device parameters. In at least one embodiment, a selection of a value of device parameter is based at least in part on a selection of a cluster of possible values of the device parameter.

### CLAIM OF PRIORITY

This application claims the benefit of U.S. Provisional Application No. 63/751,169 (Attorney Docket No. 0117373-019PR0) titled “DEVICE PARAMETER OPTIMIZATION,” filed Jan. 29, 2025, the entire contents of which is incorporated herein by reference.

### TECHNICAL FIELD

At least one embodiment pertains to processing resources used to perform and facilitate machine learning. For example, at least one embodiment pertains to processors or computing systems to select device parameters according to various novel techniques described herein.

### BACKGROUND

Selecting a desirable device parameter configuration, such as an optimal device parameter configuration, can use significant memory, time, or computing resources, and such a desirable configuration can change depending on workload. Techniques for selecting desirable device parameter configurations can be improved.

### BRIEF DESCRIPTION OF DRAWINGS

FIG. 1 illustrates an example architecture that may be used to implement a data center, according to at least one embodiment;

FIG. 2 illustrates a hierarchical multi-armed bandit framework, according to at least one embodiment;

FIG. 3 illustrates arm selection, according to at least one embodiment;

FIG. 4 illustrates examples of clusters, according to at least one embodiment

FIG. 5 illustrates a flowchart of a process to perform hierarchical multi-armed bandit parameter selection, according to at least one embodiment;

FIG. 6 illustrates an example of a system that includes a driver and/or runtime including one or more libraries to provide one or more application programming interfaces (APIs), in accordance with at least one embodiment;

FIG. 7 is block diagram illustrating an example of a processor and storage, according to at least one embodiment;

FIG. 8A illustrates logic, according to at least one embodiment;

FIG. 8B illustrates logic, according to at least one embodiment;

FIG. 9 illustrates an example data center system, according to at least one embodiment; and

FIG. 10 is a block diagram illustrating a computer system, according to at least one embodiment.

### DETAILED DESCRIPTION

Selecting device settings and/or parameter values to use to configure a device or system to achieve a desirable level of performance can be challenging particularly in dynamic environments, in which desirable settings and/or parameter values may change over time. For example, demands placed on computing resources within a data center vary as workloads and/or data processed by workloads change, making selecting settings and/or parameter values to use to configure devices and/or systems within the data center difficult. For example, storage usage can be subject to significate fluctuations based upon changes in workload demands on storage systems and/or storage devices.

Various techniques and/or devices may be used to select device settings and/or parameter values (e.g., settings and/or parameter values used to configure storage devices) to improve performance. For example, a multi-armed bandit (MAB) framework, such as hierarchical MAB framework, may be used to select device parameter values by using probabilistic and/or other algorithms (e.g., an EXP3 algorithm) to balance exploration and exploitation of different device parameter values. Such a MAB framework may generate clusters of possible setting and/or parameter values and choosing from these clusters. Once a cluster, or multiple clusters, is/are selected, the MAB framework may choose a set of device setting and/or parameter values from within the selected cluster(s). The selection of clusters, and selection of a set of device setting and/or parameter values from within clusters, may be performed using an EXP3 algorithm (or another suitable algorithm). Clusters may be formed, for example, by using a k-means (or other suitable) algorithm to cluster sets of device setting and/or parameter values. The clusters may also adhere to a Lipschitz condition, such that similar settings are grouped together. The selection process may be refined by updating weights corresponding to clusters and/or weights corresponding to the sets of device setting and/or parameter values within the clusters in response to selecting one of the sets, using the selected set to configure one or more real-world devices (e.g., storage devices) and/or one or more real-world systems, and observing real-world results of this configuration (e.g., performance of storage devices configured using the selected setting and/or parameter values).

As used herein, a parameter refers to any value that may used to configure a device and/or a system. By way of non-limiting examples, parameters may include settings, configurations, options, values, attributes, properties, and/or others. The MAB framework may be used to select a set of values (referred to as parameter values) corresponding to a set of parameters that may be used to configure any device and/or system.

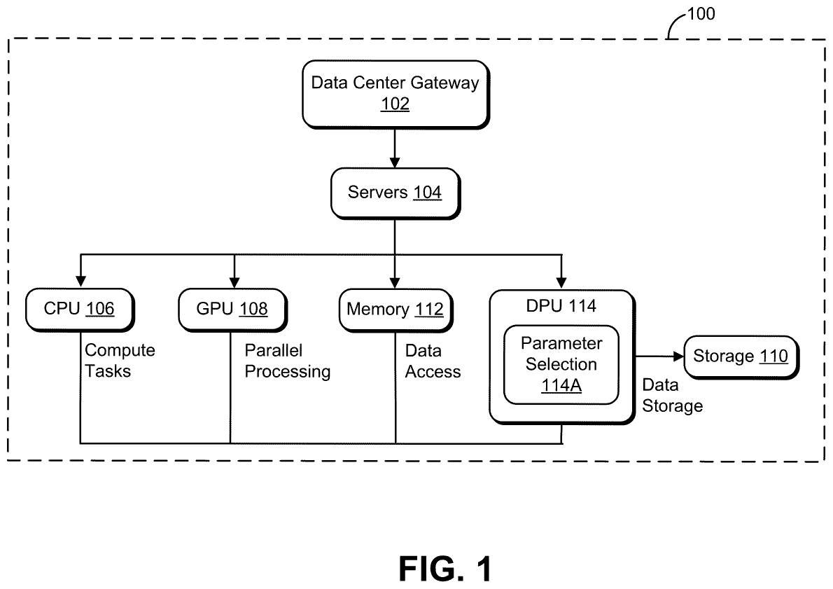

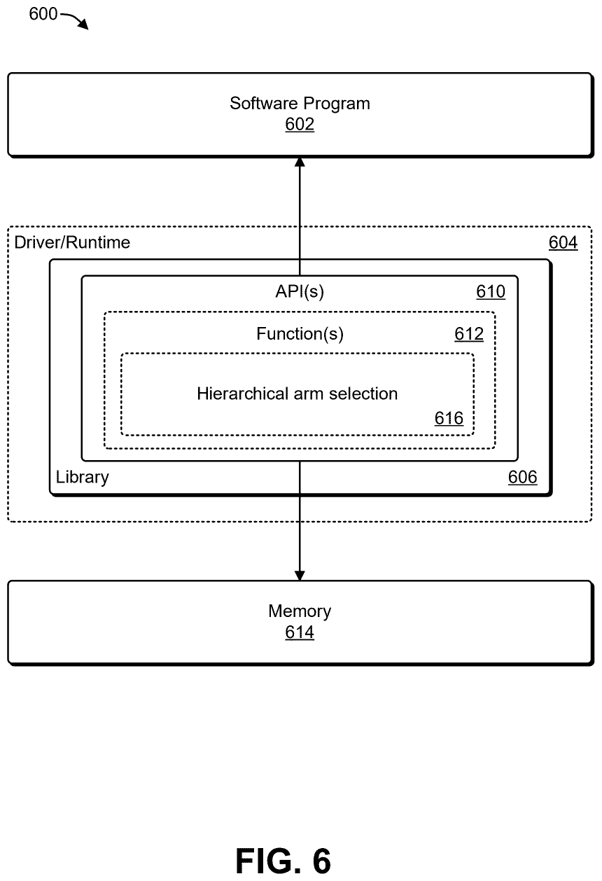

FIG. 1 illustrates an example architecture that may be used to implement a data center 100. The data center 100 may include a variety of software and hardware for storage, management, and dissemination of data and information, which may allow data to be processed and retrieved efficiently. Details of components that may additionally be included in the data center 100 are provided further below with reference to FIG. 6.

In at least one embodiment, the data center 100 includes a data center gateway 102 and servers 104. In at least one embodiment, the data center gateway 102 receives incoming data streams and includes hardware and associated software to receive and distribute data from the data streams to other components of the data center 100. The hardware may include, as non-limiting examples, network interface cards (NICs) to facilitate reception and transmission of data packets, routers and switches to manage data flow between external sources of the data streams and internal components of the data center, firewalls to filter incoming data streams to prevent unauthorized access, and load balancers to distribute incoming data traffic across servers 104 to optimize resource usage.

In at least one embodiment, the data center 100 includes one or more servers 104, which are computing devices that host applications and/or provide services to end-users. In at least one embodiment, these services include file storage. For example, the server(s) 104 may each be equipped with one or more CPUs 106, one or more GPUs 108, storage 110, and/or memory 112 to manage diverse computational workloads. The server(s) 104 may be interconnected through a network infrastructure to facilitate communication and data exchange therebetween.

In at least one embodiment, the CPU(s) 106 of the server(s) 104 perform tasks, such as executing instructions and computations. For example, the CPU(s) 106 may process data by performing arithmetic and logic operations. The CPU(s) 106 may interface with other components of the server(s) 104 to coordinate performance of the tasks. For example, the CPU(s) 106 may provide instructions to the GPU(s) 108 to perform parallel processing of data.

In at least one embodiment, the GPU(s) 108 accelerate performance of tasks via parallel processing. As an example, the GPU(s) 108 may perform large-scale computations, such as those used for machine learning and data analytics. By utilizing the GPU(s) 108 in conjunction with the CPU(s) 106, computational efficiencies of the server(s) 104 may be increased.

In at least one embodiment, the storage 110 is a component of the server(s) 104 that performs data storage. For example, the storage 110 may include storage media, such as hard drives and solid-state drives, to provide high-capacity and high-seed data access. The storage 110 may maintain data integrity and support rapid data retrieval when data is requested for processing. Each of the server(s) 104 may be associated with its own dedicated (e.g., local) storage, and/or two or more of the server(s) 104 may access and use one or more shared (e.g., remote) portions of the storage 110.

In at least one embodiment, the memory 112 is a component of the server(s) 104 that provides data access. For example, the memory 112 may be random-access memory (RAM) that facilitates rapid access to data, thereby enhancing a speed and efficiency of tasks performed at the data center 100. The memory 112 may be managed to optimize resource allocation and performance.

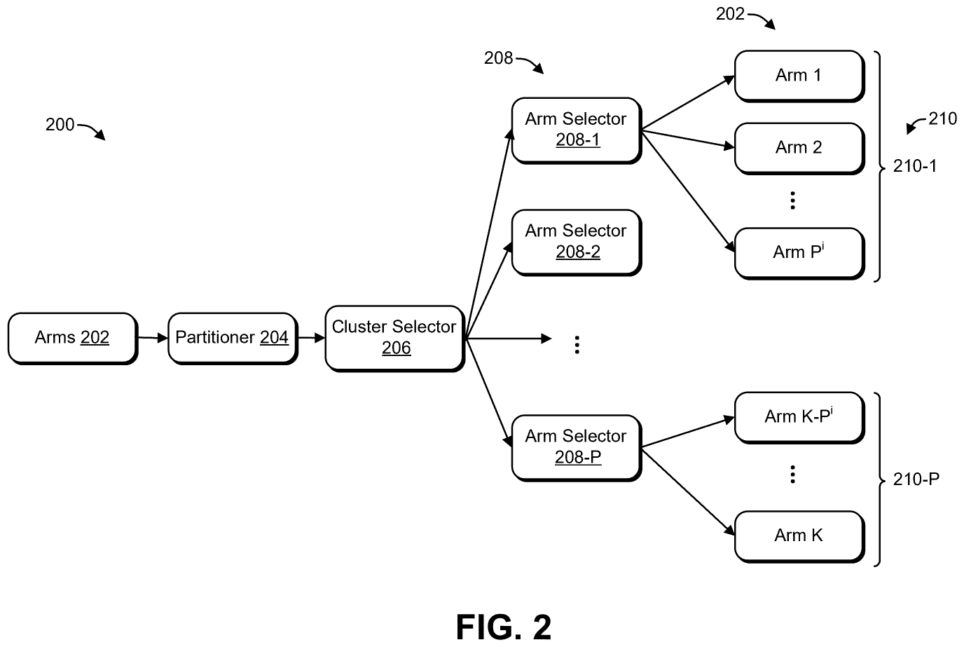

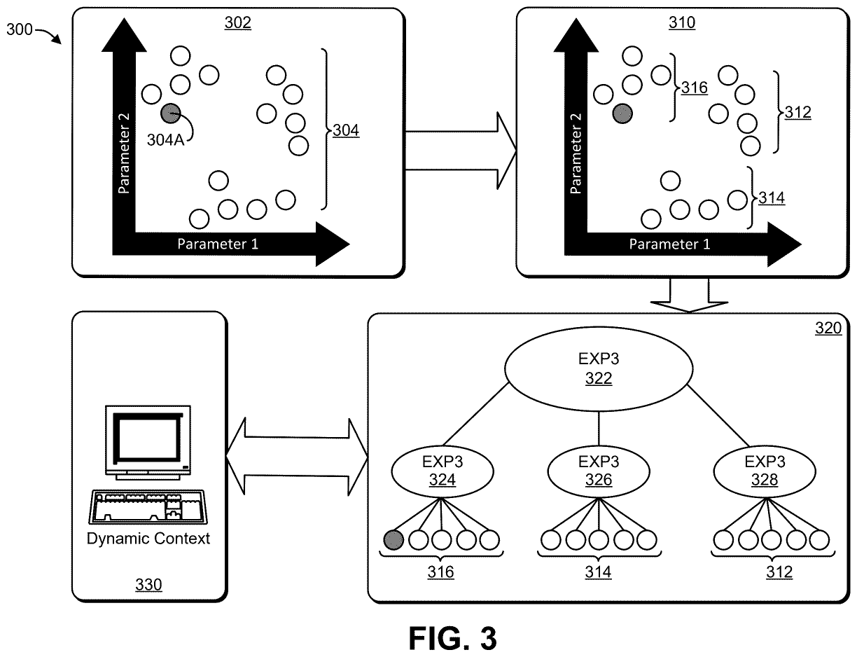

In at least one embodiment, the server(s) 104 may each be equipped with one or more data processing units (DPU(s)) 114, such as NVIDIA® BlueField® DPUs, to provide hardware-accelerated management of the storage 110. In at least one embodiment, the DPU(s) 114 implement storage-defined network accelerated processing (SNAP). In at least one embodiment, as discussed in greater detail herein and with reference to FIGS. 2 and 3, the DPU(s) 114 and/or one or more other processors (e.g., the CPU(s) 106 and/or the GPU(s) 108) perform parameter selection 114A to optimize performance of the storage 110 according to different workloads and/or other conditions. The memory 112 (e.g., one or more non-transitory machine readable media) may store instructions that when performed by at least one processor, such as the DPUs 114 and/or one or more other processors (e.g., the CPU 106 and/or the GPU(s) 108), cause the at least one processor to perform the parameter selection 114A as described herein.

In at least one embodiment, the DPU(s) 114 perform the parameter selection 114A as a multi-armed bandit (MAB) problem. The MAB problem is a problem in decision theory and machine learning, capturing the exploration-exploitation dilemma inherent in many real-world scenarios, e.g., clinical trials, online advertising, resource allocation, dynamic pricing, and/or others, such as discussed herein. For example, storage parameter optimization may be modeled as a MAB problem. In a MAB problem, an agent repeatedly chooses from a set of actions (“arms”), each yielding a reward, with the goal of maximizing cumulative reward over time, attempting to balance the need to explore different arms to learn their reward distributions with exploiting the arms that have so far yielded the highest rewards. The MAB problem may be used to model parameter section (e.g., the parameter selection 114A), and one or more MAB algorithms or methods may be used to explore and exploit options or arms defined in the MAB problem.

At least one embodiment includes modeling model parameter section as a hierarchical MAB problem in a dynamic, non-stationary environment inspired by real-world challenges, such as automated system configuration. The MAB problem may be characterized as being hierarchical because it may first select a cluster of arms, and may then select an arm from the selected cluster. Arms may be clustered within a metric space and/or exhibit Lipschitz properties. In at least one embodiment, the MAB problem is applied to a non-stationary landscape where the reward of each arm can evolve over time, reflecting, for example, the changing performance of different system configurations under a fluctuating workload. The arms may not be independent and/or the arms may be grouped into clusters based on a predefined metric representing the similarity of configurations.

FIG. 2 illustrates a hierarchical multi-armed bandit framework 200, according to at least one embodiment. The framework 200 may be implemented by one or more of the server(s) 104 (see FIG. 1). For example, instructions (e.g., stored by one or more non-transitory machine readable media, such as at least a portion of the memory 112) may be executed by the DPU(s) 114 and may implement at least a portion of the framework 200.

In at least one embodiment, the framework 200 (e.g., performed by the DPU(s) 114) performs the parameter selection 114A illustrated in FIG. 1. Referring to FIG. 2, in at least one embodiment, the framework 200 represents an adversarial Lipschitz MAB problem. The adversary in the adversarial Lipschitz MAB problem may be an oblivious adversary. In at least one embodiment, the framework 200 is implemented using one or more exponential-weight algorithms for exploration and exploitation (EXP3 algorithms). In at least one embodiment, EXP3 and/or another probabilistic algorithm that uses exponential weighting to balance exploration and exploitation in an adversarial bandit setting may be used to implement the framework 200. EXP3 may operate by maintaining and/or updating a probability distribution over available actions (or arms) based on observed rewards.

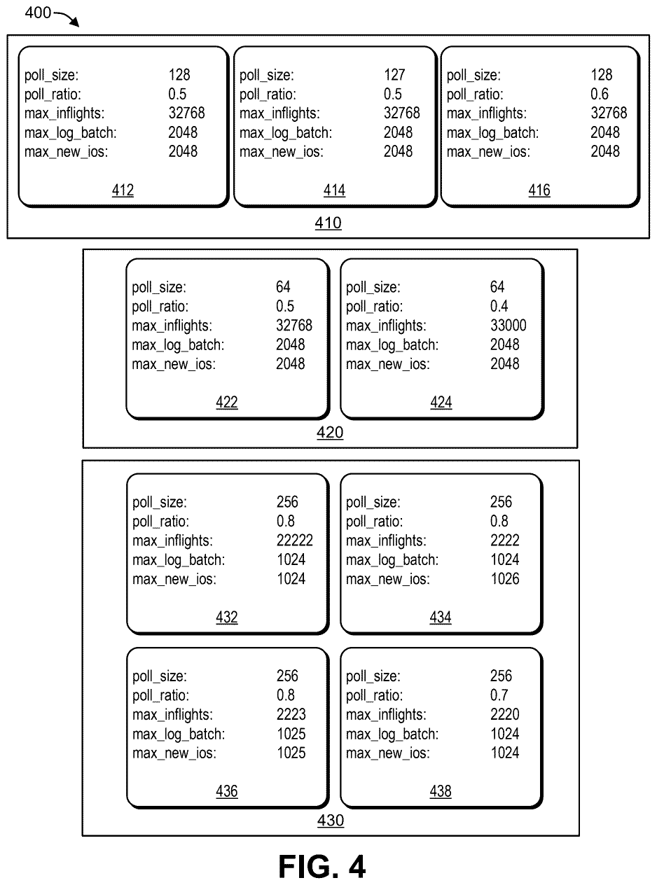

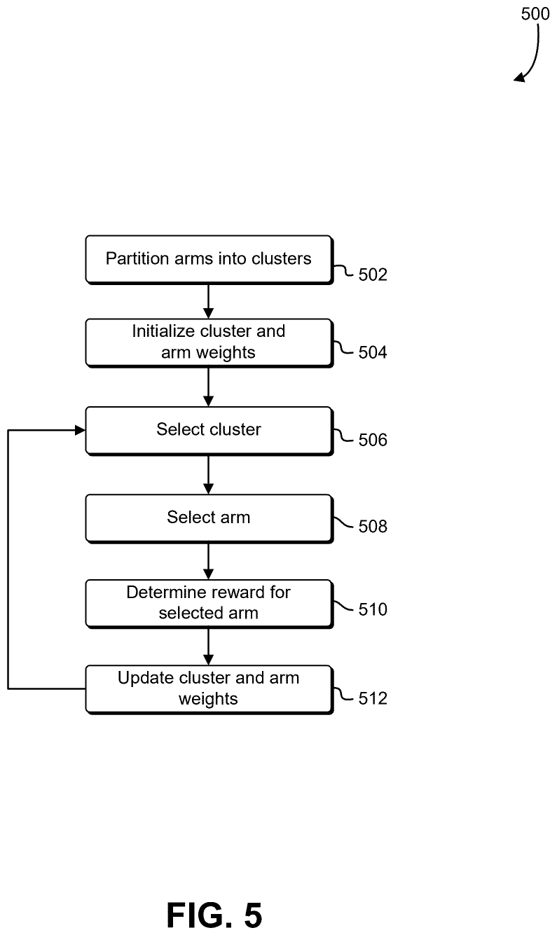

In at least one embodiment, arms 202 represent different configurations of parameters that may be selected. The arms 202 may be arms of a MAB problem. An arm constructor process (not shown) may be used to define the arms 202 (e.g., using system configuration information). The arm constructor process may select values of parameters to assign to the arms 202 using any suitable method, such as by identifying sets of possible parameter values, and assigning a different one of the sets to each of the arms 202. By way of another non-limiting example, the arm constructor process may select (e.g., randomly or pseudo randomly) a value of each parameter to assign to each of arms 202. As discussed in greater detail with reference to FIGS. 4 and 5, parameters may, for example, control a number of I/O requests to be processed, a rate at which I/O requests are processed, and/or which devices process I/O requests.

In at least one embodiment, a partitioner 204 groups the arms 202 into clusters 210. This grouping may be performed using a K-means algorithm, or any other suitable clustering algorithm. In at least one embodiment, the grouping is performed based on predefined expert knowledge. The partitioner 204 may perform clustering such that the arms 202 within a cluster are similar to one another, for example within a certain distance of each other when encoded into a vector space. In at least one embodiment, within each cluster, the rewards for selecting the arms adhere to a Lipschitz condition, implying that configurations that are close to one another (e.g., include similar parameter settings) will yield similar performance results, even as the optimal configuration shifts with the changing environment. While the best configuration for a system might change with the workload, configurations with similar parameter settings may generally exhibit similar performance levels. In at least one embodiment, the framework 200 is a traveling arms framework that uses one or more algorithms that efficiently learn and adapt to the changing reward landscape while leveraging the structural information encoded by the clustered, Lipschitz nature of the arms.

In at least one embodiment, a cluster selector 206 selects one or more of the clusters 210 that each include one or more of the arms 202. In at least one embodiment, the cluster selector 206 is a MAB (e.g., performs one or more EXP3 algorithms and/or one or more other probabilistic algorithms). For example, in FIG. 2, the arms 202 may include a number K of arms and may be divided into a number P of clusters 210-1 to 210-P. Each of the clusters 210 may include a number Pⁱ of clusters. The clusters 210 may each include the same number of arms or at least two of the clusters 210 may include different numbers of the arms 202. For ease of illustration, the cluster selector 206 may select the cluster 210-1.

In at least one embodiment, for one or more of these selected clusters (e.g., the cluster 210-1), one or more arm selectors 208 select one or more of the arms 202 in the cluster. In at least one embodiment, each of the arm selector(s) 208 is a MAB (e.g., performs one or more EXP3 algorithms and/or one or more other probabilistic algorithms). The framework 200 may include a different one of the arm selector(s) 208 for each of the clusters 210, and/or may include an arm selector for each of the one or more selected clusters to select one of the arms within the selected cluster.

In at least one embodiment, selected arm(s) is/are pulled, e.g., one or more parameters corresponding to the selected arm(s) is/are implemented, and a reward corresponding to the selected arm(s), e.g., a change in performance, is observed. Rewards may include, for example, telemetry data from storage devices indicating factors such as read/write speed, device utilization, power efficiency, error rate, and/or any other suitable performance metrics. The cluster selector 206 and/or the arm selector(s) 208 may each be associated with a weight value. In at least one embodiment, the weight value associated with each of the cluster selector 206 and/or the arm selector(s) 208 is/are updated according to the observed reward(s), for example to cause future selections to favor clusters and/or arms that resulted in higher performance.

After one or more of the arms 202 has been selected and implemented, the cluster selector 206 may select one or more new clusters, and/or the arm selector(s) 208 may select one or more new arms to be implemented. This process may repeat any number of times (e.g., may run continuously) to adjust system and/or storage parameters.

The parameter values of a pulled arm may be used to configure one or more configurable components to perform one or more tasks (e.g., in an environment that changes unpredictably over time). For example, the parameter values may be used to configure configurable component(s) of the data center 100. By way of non-limiting examples, the configurable component(s) may include one or more devices and/or one or more system such as one or more storage systems (e.g., disk controller(s), storage array(s), the storage 110, etc.), one or more network devices (e.g., one or more routers, switches, and/or other network equipment), one or more of the server(s) 104, one or more embedded systems (e.g., one or more devices with limited resources, such as IoT device(s), embedded system(s), etc.), and/or one or more other devices. A storage system may include hardware components (e.g., hard disk drives, solid state drives, controllers, etc.) as well as software components (e.g., operating system(s), management software, etc.) that may be configured using the parameter values.

In at least one embodiment, the cluster selector 206 and/or the arm selector(s) 208 perform selection according to the following equations, definitions, and/or algorithms.

The problem instance is a triple (K, D, C), where K is the set of k arms {1, 2, . . . , k}, (K, D) is a metric space, and C is a rewards assignment, e.g., an infinite sequence c₁, c₂, . . . of vectors cₜ=(cₜ(1), . . . , cₜ(k)), where cₜ:K→[0, 1] is a Lipschitz function on (K, D) with Lipschitz constant 1 at time t. In at least one embodiment, this may formally be expressed as Equation (Eq.) 1 below:

$$\vert {c}_{t} ( a ) - {c}_{t} ( {a}^{′} ) \vert \leq D ( a , {a}^{′} ) for all arms a , {a}^{′} ∈ K and all rounds t \qquad Eq . 1$$

In Eq. 1 above, D(a, a′) is the distance between a and a′ in D.

In at least one embodiment, [symbol] is a partition of K where p is the number of clusters in the part partition and P¹ . . . . P^{p} are the mutually exclusive clusters where for each 1≤i≤p, Pⁱ⊆K, and |Pⁱ|>0.

For an algorithm A that selects arm aₜ at time t, cost may be considered using Eq. 2 below:

$${G}_{A} ( T ) {=}^{def} {\sum }_{t = 1}^{T} {c}_{t} ( {a}_{t} ) \qquad Eq . 2$$

In at least one embodiment, a best arm in hindsight may be defined using Eq. 3 below:

$${G}_{max} ( T ) {=}^{def} {max}_{a ∈ K} {\sum }_{t = 1}^{T} {c}_{t} ( a ) \qquad Eq . 3$$

In at least one embodiment, the weak regret of the algorithm A is defined using Eq. 4 below:

$${G}_{max} ( T ) - {G}_{A} ( T ) \qquad Eq . 4$$

In at least one embodiment, expected weak regret is defined using Eq. 5:

$${G}_{max} ( T ) - 𝔼 [ {G}_{A} ( T ) ] \qquad Eq . 5$$

In at least one embodiment, the algorithm A is provided below:

Input: A partition [symbol] of the arms to clusters
1: Initialize: set cluster weights wᵢ(1) = 1 for i ∈ K. Set arms weights wᵢⱼ(1) = 1 for all
arms, i ∈ K, 1 ≤ j ≤ |Pⁱ |
2: for t = 1 to T do

| | |
|---|---|
| 3: | (a) Cluster selection using EXP3 on clusters, Pₜ ∈ [symbol] is the selected cluster. |
| 4: | (b) Arm selection using EXP3 on arms in the selected cluster. aₜ ∈ Pₜ is the selected |
| | arm. |
| 5: | (c) Pull aₜ, observe reward cₜ. |
| 6: | (d) Update the arms-level weight for arm aₜ ∈ Pₜ using the reward cₜ. |
| 7: | (e) Update cluster-level weights for cluster Pₜ using the reward cₜ. |

8: end for

While the example algorithm A above includes using EXP3, one or more other a probabilistic algorithms may be used in algorithm A instead of or in addition to EXP3. In at least one embodiment, if the arms are stochastic and/or nonstationary, a stochastic algorithm (e.g., an upper confidence bound algorithm) may be used.

In at least one embodiment, in a hierarchical multi-armed bandit setup, the total regret can be expressed as the sum of two components. The first component is regret for choosing the cluster, which is the regret incurred by the first-level bandit in selecting a cluster, defined by the cluster containing the globally best arm. The second component is regret within the cluster, which is the regret incurred by the second-level bandit in selecting an arm within the chosen cluster, relative to the best arm in that cluster.

In at least one embodiment, the framework 200 uses general clustering such that P is a partition (clustering) of K where p is the number of clusters and Pⁱ, . . . , P^{p} are the mutually exclusive and collectively exhaustive clusters where for each 1≤i≤p, Pⁱ⊆K and |Pⁱ|>0. In at least one embodiment, double-EXP3 is an EXP3 working on P, e.g., as shown in the algorithm A above, where Tⁱ is the number of times the algorithm visits cluster i. In at least one embodiment, t(i, j)≤T denotes the time in which the algorithm visited cluster i for the j-th time.

In at least one embodiment, a best arm in hindsight is defined as a*∈P*, where p*=|P*| denotes the size of the cluster that holds a*. P⁺ may be defined as the best cluster in hindsight, e.g., the cluster that should have been played constantly by the first-level EXP3 to maximize:

$${G}_{max P} ( T ) = {max}_{i ∈ K} {\sum }_{t = 1}^{T} {c}_{t} ( {P}^{i} ) \qquad Eq . 6$$

In at least one embodiment, for each cluster, a best cost in hindsight may be defined as:

$${G}_{{max P}^{i}} ( {T}^{i} ) = {max}_{a ∈ {P}^{i}} {\sum }_{j = 1}^{\vert {T}^{i} \vert} {c}_{t ( i , j )} ( a ) \qquad Eq . 7$$

In at least one embodiment, Eqs. 8-11 define additional values:

$${G}_{max} ( P , T ) = {max}_{a ∈ P} {\sum }_{t = 1}^{T} {c}_{t} ( a ) \qquad Eq . 8$$

$${G}_{max} ( T ) = {max}_{a} {\sum }_{t = 1}^{T} {c}_{t} ( a ) = {max}_{P ∈ 𝒫} {G}_{max} ( P , T ) \qquad Eq . 9$$

$${a}^{*} ( T ) = arg {max}_{a} {\sum }_{t = 1}^{T} {c}_{t} ( a ) \qquad Eq . 10$$

$${P}^{* *} ( T ) = arg {max}_{i ∈ K} {\sum }_{t = 1}^{T} {c}_{t} ( {P}^{i} ) \qquad Eq . 11$$

In at least one embodiment, the expected weak regret of double EXP3 can be bounded by analyzing the regret resulting from the relevant EXP3 algorithms. In at least one embodiment, at the top (parent) level, the regret is with respect to the Gₘₐₓ playing with P arms. At the lower (child) level the regret is computed within each cluster using its EXP3 copy.

In at least one embodiment, for the Top level EXP3, the regret of not choosing the best cluster P** during all times up to T may be determined using Eq. 13 below:

$${G}_{max P} ( T ) - {\sum }_{t = 1}^{T} {c}_{t} ( {P}_{t} ) = {G}_{max P} ( T ) - {\sum }_{i = 1}^{p} {\sum }_{t = 1}^{\vert {T}^{i} \vert} {c}_{t ( i , j )} ( {P}^{i} ) \qquad Eq . 13$$

In at least one embodiment, for the Top level, the regret for not choosing the cluster P* and selecting within always a* may be determined using Eq. 14 below:

$${G}_{max} ( T ) - {G}_{max P} ( T ) \qquad Eq . 14$$

In at least one embodiment, for the Lower level, the regret in each cluster not playing its best arm all the time may be determined using Eq. 15 below:

$${\sum }_{i = 1}^{p} ( {G}_{{max p}^{i}} ( {T}^{i} ) - {\sum }_{t = 1}^{{T}^{i}} {c}_{t ( i , j )} ( {a}_{t ( i , j )} ) ) \qquad Eq . 15$$

In at least one embodiment, the expressions of Eq. 16-18 hold or remain true:

$$𝔼 [ {G}_{max P} ( T ) - {\sum }_{t = 1}^{T} {c}_{t} ( {P}_{t} ) ] \leq O ( \sqrt{pT log p} ) \qquad Eq . 16$$

$$𝔼 [ {G}_{max} - {G}_{max P} ( T ) ] \leq O ( \sqrt{{p}^{*} T log {p}^{*}} ) \qquad Eq . 17$$

$$𝔼 [ {\sum }_{i = 1}^{p} ( {G}_{{max P}^{i}} ( {T}^{i} ) - {\sum }_{t = 1}^{\vert {T}^{i} \vert} {c}_{t ( i , j )} ( {a}_{t ( i , j )} ) ) ] \leq O ( \sqrt{kT log \frac{k}{p}} ) \qquad Eq . 18$$

In at least one embodiment, the above follows from running EXP3 on the clusters, each as a virtual arm; there are p clusters, and the regret is with respect to playing the best cluster P⁺ (virtual arm) in hindsight, so the results follow from the EXP3 bound, which may be expressed by Eqs. 19-21:

$$𝔼 [ {G}_{max} - {G}_{max P} ( T ) ] = {G}_{max} - 𝔼 [ {\sum }_{t = 1}^{T} {c}_{t} ( {P}^{+} ) ] \qquad Eq . 19$$

$$\leq {G}_{max} - 𝔼 [ {\sum }_{t = 1}^{T} {c}_{t} ( {P}^{*} ) ] \qquad Eq . 20$$

$$\leq O ( \sqrt{{p}^{*} T log {p}^{*}} ) , \qquad Eq . 21$$

In Eqs. 19-21 above, the first inequality (e.g., Eq. 20) follows since cluster P⁺ has the largest expected reward, at least as large as cluster P*, and the last inequality (e.g., Eq. 21) follows from the EXP3 bound in the cluster P* for which a*∈P*. In at least one embodiment, the Eq. 22 below results from running EXP3 in each cluster:

$$𝔼 [ {\sum }_{i = 1}^{p} ( {G}_{{maxP}_{i}} ( {T}^{i} ) - {\sum }_{t = 1}^{{T}^{i}} {c}_{t ( i , j )} ( {a}_{t ( i , j )} ) ) ] \leq {\sum }_{i = 1}^{p} O ( \sqrt{\vert {P}^{i} \vert {T}^{i} log \vert {P}^{i} \vert} ) \leq O ( \sqrt{kT log \frac{k}{p}} ) \qquad Eq . 22$$

In Eq. 22 above, the third term follows for the concavity of the function and under the constraints Σ|Pⁱ|=k and Σ|Tⁱ|=T the worst case is

$${∀}_{i} , \vert {P}^{i} \vert = \frac{k}{p} and \vert {T}^{i} \vert = \frac{T}{p} .$$

In at least one embodiment, for k nonstochastic arms, T>0 and a partition P of the arms, the weak regret of the double EXP3 is bounded according to Eq. 23 below:

$${G}_{max} - 𝔼 [ {G}_{double - EXP3} ] \leq O ( \sqrt{pT log p} ) + O ( \sqrt{{p}^{*} T log {p}^{*}} ) + O ( \sqrt{kT log \frac{k}{p}} ) \qquad Eq . 23$$

In at least one embodiment, the rewards of the arms form a metric space, e.g., having Lipschitz conditions ensuring that the rewards of all arms in a cluster are close to each other. In at least one embodiment, there is no requirement for a condition for the distance between clusters. Such a situation fits, for example, in a system optimization problem where each arm corresponds to a set of system parameters trying to optimize a certain metric (e.g., power, delay, etc.). In at least one embodiment, the set of potential arms is very large since each parameter to many possible values. In at least one embodiment, a smoothness condition is assumed on each parameter, such that each minor change of a parameter results in a minor change of the outcome. In at least one embodiment, the state of the system (e.g., number of active jobs) is unknown or even changing over time (e.g., as new jobs come and go), but for every state, the Lipschitz condition holds. More formally, arms on partition [symbol] are an [symbol] -partition if the following condition defined by Eq. 24 holds:

$$∀ P ∈ 𝒫 , a , b ∈ P \vert {c}_{t} ( a ) - t ( b ) \vert \leq ℓ for all rounds t \qquad Eq . 24$$

In at least one embodiment, for k nonstochastic arms, T>0 and an [symbol] -partition [symbol] of the arms, the weak regret of the double-EXP3 algorithm is bounded according to Eq. 25 below:

$${G}_{max} - 𝔼 [ {G}_{d o u b l e - E X P 3} ] \leq O ( \sqrt{pT log p} ) + O ( \sqrt{{p}^{*} T log {p}^{*}} ) + T \cdot ℓ \qquad Eq . 25$$

In at least one embodiment, the above bound does not assume any contribution to the running of EXP3 in the cluster, and using EXP3 within each Lipschitz cluster allows improvement of the result.

In at least one embodiment, for k nonstochastic arms, T>0 and an [symbol] -partition [symbol] of the arms, the weak regret of the double-EXP3 algorithm is bounded according to Eq. 26 below:

$${G}_{max} - 𝔼 [ {G}_{d o u b l e - E X P 3} ] \leq O ( \sqrt{pT log p} ) + O ( \sqrt{{p}^{*} T log {p}^{*}} ) + O ( ℓ \sqrt{kT log \frac{k}{p}} \qquad Eq . 26$$

In at least one embodiment, the results hold for nonstochastic arms, which keeps the Lipschitz condition; comparing the upper bound of the flat EXP3, improvement may be achieved when the number of clusters is relatively small, e.g., p<<k, the size of the best cluster is relatively small, e.g., p*<<k and when the Lipschitz constant is sufficiently small, e.g.,

$$ℓ \leq \frac{1}{\sqrt{k}} .$$

FIG. 3 illustrates an arm selection process 300, according to at least one embodiment. The arm selection process 300 may be implemented by one or more of the server(s) 104 (see FIG. 1). For example, instructions (e.g., stored by one or more non-transitory machine readable media, such as at least a portion of the memory 112) may be executed by the DPU(s) 114 and may implement at least a portion of the arm selection process 300. In at least one embodiment, the arm selection process 300 may at least partially implement the parameter selection 114A illustrated in FIG. 1 and/or at least partially be performed using the framework 200 illustrated in FIG. 2.

In at least one embodiment, the arm selection process 300 includes representing arms 304 in a metric space 302. In the metric space 302, different dimensions correspond to different parameters (e.g., device parameters). By way of a non-limiting example the metric space 302 illustrated in FIG. 3 includes two dimensions corresponding to Parameters 1 and 2. However, the metric space 302 may include any number of dimensions corresponding to parameters, including a single dimension corresponding to a single parameter. The arms 304 represent points in the metric space 302 determined by values of the parameters assigned to the arms 304 (e.g., by an arm constructor process, not shown). In at least one embodiment, the arms 304 include a desirable (e.g., optimal) arm 304A. In at least one embodiment, the arms 304 include multiple desirable and/or optimal arms. The arm 304A may be considered desirable because desirable results are obtained by a device or a system (e.g., the storage 110, the data center 100, one or more of the server(s), and/or others) configured using the parameters assigned to the arm 304A. For example, the arm 304A may be considered desirable because desirable performance is obtained with respect to accessing the storage 110 (e.g., at least a threshold number of input/output operations per second (IOPS) may be performed, a maximum number of IOPS may be performed, and/or other performance criteria is satisfied). For example, one or more of the following performance metrics may be monitored after the system is configured with the parameter values assigned to a particular one of the arms 304, and used to determine whether the parameter values assigned to the particular arm result in better performance by the system than parameter values assigned to one or more of the other arms: latency, throughput, IOPS, capacity utilization, reliability, availability, data transfer rate, error rate, scalability, energy efficiency, and/or others. In at least one embodiment, the arms 304 correspond to the arms 202 illustrated in FIG. 2.

The arm selection process 300 may include grouping the arms 304 into clusters 310 (e.g., using one or more clustering algorithms). In at least one embodiment, referring to FIG. 3, a partitioner (e.g., the partitioner 204 illustrated in FIG. 2) divides the arms 304 into clusters 310. In the example illustrated in FIG. 3, clusters 310 include clusters 312, 314, and 316, where the cluster 316 includes the desirable arm 304A.

The arm selection process 300 may include selecting one of the clusters 310 (e.g., using multi-armed bandit algorithm(s), such as adversarial bandit algorithm(s), like the EXP3 algorithm), and selecting one of the arms 304 from the selected cluster (e.g., using multi-armed bandit algorithm(s), such as adversarial bandit algorithm(s), like the EXP3 algorithm). In at least one embodiment, a cluster selector (e.g., cluster selector 206) and/or arm selector(s) (e.g., arm selectors 208) perform a cluster and arm selection process 320. Cluster selection may be performed using an EXP3 algorithm 322, for example as discussed above with reference to FIG. 2, algorithm 1, and/or Eqs. 1-26. In the illustrated example of FIG. 3, the EXP3 algorithm 322 selects cluster 316, which includes the desirable arm 304A. In at least one embodiment, the EXP3 algorithm 322 is replaced by any other suitable algorithm.

The arm selector(s) that perform at least a portion of the cluster and arm selection process 320 may each implement at least one instance of an EXP3 algorithm and/or any other suitable algorithm(s). In at least one embodiment, the arm selector(s) that perform at least a portion of the cluster and arm selection process 320 perform instances 324, 326, and 328 of the EXP3 algorithm with respect to a cluster selected by the EXP3 algorithm 322. While the cluster and arm selection process 320 has been illustrated as performing the three instances 324, 326, and 328 of the EXP3 algorithm, the arm selector(s) may perform of any number of instances of the EXP3 algorithm, including a single instance. The same EXP3 algorithm or a different EXP3 algorithm may be performed by the cluster selector and one or more of the arm selector(s). Two or more of the instances of the EXP3 algorithm (e.g., instances 324, 326, and 328) performed by the arm selector(s) may perform the same EXP3 algorithm. Two or more of the instances of the EXP3 algorithm (e.g., instances 324, 326, and 328) performed by the arm selector(s) may perform different EXP3 algorithms. In the example illustrated in FIG. 3, the instance 324 of the EXP3 algorithm selects an arm (e.g., the desirable arm 304A) from the cluster 316. In at least one embodiment, instead of the EXP3 algorithm, the arm selector(s) may use any other suitable algorithm(s) to select an arm from the selected cluster.

The arm selection process 300 may include providing one or more parameter values assigned to the selected arm (e.g., by the arm constructor process) to a system 330. In at least one embodiment, the system 330 receives the parameter values corresponding to the arm (e.g., optimal arm 304A) selected by the cluster and arm selection process 320. The system 330 may implement and/or may operate within a dynamic context, which is an environment that is subject to change and/or variability over time. The system 330 may be all or part of the datacenter 100 illustrated in FIG. 1. Returning to FIG. 3, the system 330 may apply these parameter values to one or more storage devices (e.g., the storage 110) and/or one or more other components, for example, of the system 330 or accessible thereby. In at least one embodiment, the system 330 measures performance of the storage device(s) and/or other component(s) using the received parameter values (e.g., performance metrics), and updates (e.g., via the DPU(s) 114) weights associated with the clusters 310 and/or weights associated with the arms 304 for future performance of the cluster and arm selection process 320. For example, the cluster and arm selection process 320 may be performed repeatedly (e.g., periodically, continuously, and/or the like) over a period of time to improve performance of the storage device(s) (e.g., the storage 110) and/or other component(s). An automated process (e.g., performed by the DPU(s) 114 and/or one or more other processors, such as one or more of the CPU(s) 106 and/or one or more of the GPU(s) 108) may cause the cluster and arm selection process 320 to be performed, for example, if performance of the storage device(s) (e.g., the storage 110) and/or other component(s) falls below one or more threshold values. By way of another non-limiting example, the cluster and arm selection process 320 may be performed in response to a user request.

FIG. 4 illustrates example clusters 400, according to at least one embodiment. In the illustrated example of FIG. 4, the clusters 400 includes cluster 410, cluster 420, and cluster 430. In at least one embodiment, the clusters 400 correspond to clusters 210-1 to 210-P illustrate in FIG. 2, the clusters 312-316 illustrated in FIG. 3, and/or any other suitable clusters, such as those described herein. The clusters 410, 420, and 430 each include sets of values for a set of parameters. Each of the sets of values may be characterized as being an arm of a MAB problem. In the illustrated example of FIG. 4, the set of parameters includes a poll_size parameter, poll_ratio parameter, a max_inflights parameter, a max_log_batch parameter, and a max_new_ios parameter, which are discussed in greater detail with reference to FIG. 5. In at least one embodiment, the set of parameters illustrated includes different parameters than those illustrated in FIG. 4, at least some of those illustrated in FIG. 4, and/or additional suitable parameters.

The cluster 410 is an example of a cluster including three sets of parameter values 412, 414, and 416. In at least one embodiment, the sets of parameter values 412, 414, and 416 are implementations of the arms 202. The sets of parameter values 412, 414, and 416 were clustered into the same cluster 410 because of similarities in their parameter values. For example, the sets of parameter values 412, 414, and 416 may be identical except for slight differences in the values of the poll_size parameter and the poll_ratio parameter. The sets of parameter values 412, 414, and 416 are sufficiently similar so as to be included in the same cluster, for example, as determined by the cluster selector 206 (see FIG. 2).

The cluster 420 is an example of a cluster including two sets of parameter values 422 and 424. In at least one embodiment, the sets of parameter values 422 and 424 are implementations of the arms 202. In the example cluster 420, the sets of parameter values 422 and 424 may be identical except for slight differences in the values of the max_inflights parameter and the poll_ratio parameter. The sets of parameter values 422 and 424 are sufficiently similar to each other so as to be included in the same cluster, but sufficiently different from the sets of parameter values 412, 414, and 416 so as to not be included in the cluster 410, for example, as determined by the cluster selector 206.

The cluster 430 is an example of a cluster including four sets of parameter values 432, 434, 436, and 438. In at least one embodiment, the sets of parameter values 432, 434, 436, and 436 are implementations of the arms 202. In the example cluster 430, the value of the poll_size parameter is 256 in the sets of parameter values 432, 434, 436, and 438, but the sets of parameter values 432, 434, 436, and 438 have slight differences in the values of the poll_ratio parameter, the max_inflights parameter, the max_log_batch parameter, and/or the max_new_ios parameter. The sets of parameter values 432, 434, 436, and 438 are sufficiently similar to one another so as to be included in the same cluster, but sufficiently different from the sets of parameter values 412, 414, 416, 422, and 424 so as to not be included in the clusters 410 or 412, for example as determined, by the cluster selector 206.

While the examples illustrated in FIG. 4 include clusters including two to four sets of parameter values, embodiments may include clusters having one set of parameter values and/or greater than four sets of parameter values. In at least one embodiment, a cluster may include sets of parameter values having differences greater than those illustrated in FIG. 4. In at least one embodiment, the sets of parameter values may be excluded from a cluster based on differences smaller than those within a cluster illustrated in FIG. 4.

FIG. 5 illustrates a flowchart of a process 500 to perform parameter selection, according to at least one embodiment. For example, the process 500 may perform hierarchical multi-armed bandit parameter selection. The process 500 may be used, for example, to select one or more device parameter values based, at least in part, on generating one or more clusters of possible values of one or more device parameters, and selecting one or more of the clusters. The process 500 may be performed at least in part by the system 100. The process 500 may be performed by one or more processors (e.g., by the DPU(s) 114 illustrated in FIG. 1) performing processor executable instructions, for example, stored in at least one non-transitory computer readable media. Such processor executable instructions may implement the parameter selection 114A (see FIG. 1), which may perform at least a portion of the process 500. The process 500 may implement the double-EXP3 algorithm and/or algorithm A described herein.

In at least one embodiment, the process 500, at block 502, includes partitioning or clustering a number of arms (e.g., sets of parameter values) into clusters. The arms may represent, for example, different configurations of a configurable component (e.g., sets of parameter values to be used to configure the component), such as the storage 110 and/or another component. Non-limiting examples of parameters include one or more of the following:
a poll_size parameter, which is a maximum number of existing I/Os to be processed in a single polling cycle;
a poll_ratio parameter, which is the rate in which poll cycles occur;
a max_inflights parameter, which is a maximum number of inflight I/Os per DPU core;
a max_iog_batch parameter, which is a maximum fairness batch size (how many I/Os to poll from a specific block device before moving to the next one); or
a max_new_ios parameter, which is a maximum number of new I/Os to handle in a single poll cycle.

The parameters may include parameters in addition to those listed above. In at least one embodiment, the process 500 is used to select values for any suitable parameters, and/or parameters for applications other than storage. In at least one embodiment, block 502 is performed by the partitioner 204 illustrated in FIG. 2.

In at least one embodiment, the process 500, at block 504, includes initializing cluster and arm weights (e.g., by the DPU(s) 114 illustrated in FIG. 1). In at least one embodiment, this initialization is performed as described with reference to the algorithm A, as discussed herein.

In at least one embodiment, the process 500, at block 506, includes selecting one or more of the clusters (e.g., by the DPU(s) 114 illustrated in FIG. 1). In at least one embodiment, the selection is performed based on an EXP3 algorithm (e.g., as discussed with reference to FIG. 2) and/or one or more other probabilistic algorithms. In at least one embodiment, the selection is performed using any other suitable algorithm. In at least one embodiment, the selection is performed by the cluster selector 206. This selection may be performed based, at least in part, on a predicted outcome of selecting the cluster.

In at least one embodiment, the process 500, at block 508, includes selecting one or more arms (e.g., by the DPU(s) 114 illustrated in FIG. 1) from one or more of the cluster(s) selected in block 506. In at least one embodiment, the selection is performed based on an EXP3 algorithm (e.g., as described with reference to FIG. 2) and/or one or more other a probabilistic algorithms. In at least one embodiment, the selection is performed using any other suitable algorithm. In at least one embodiment, the arm(s) is/are selected by the arm selector(s) 208. This selection may be performed based, at least in part, on a predicted outcome of selecting the arm.

In at least one embodiment, the process 500, at block 510, includes determining one or more rewards (e.g., by the DPU(s) 114 illustrated in FIG. 1) associated with the arm(s) selected in block 508. In at least one embodiment, determining the reward(s) includes determining regret of selecting the arm(s) (e.g., as discussed with reference to Eqs. 4, 5, 13, 14, 19-21, 23, 25, and/or 26). In at least one embodiment, determining the reward(s) for the selected arm(s) is performed as discussed above with reference to FIG. 2. Determining the reward(s) and/or regret(s) may include obtaining one or more performance metrics associated with one or more configurable components that was/were configured using the parameter value(s) assigned to the arm(s) selected in block 508, and generating the reward(s) and/or regret(s) using the performance metric(s).

In at least one embodiment, the process 500, at block 512, includes updating the cluster and/or arm weights (e.g., by the DPU(s) 114 illustrated in FIG. 1) based, at least in part, on the determined reward(s) and/or regret(s). In at least one embodiment, updating the weights is performed as discussed above with reference to FIG. 2. In at least one embodiment, block 512 includes updating actual outcomes associated with selecting the arm. If additional clusters and/or arms are to be selected, the process 500 may return to block 506.

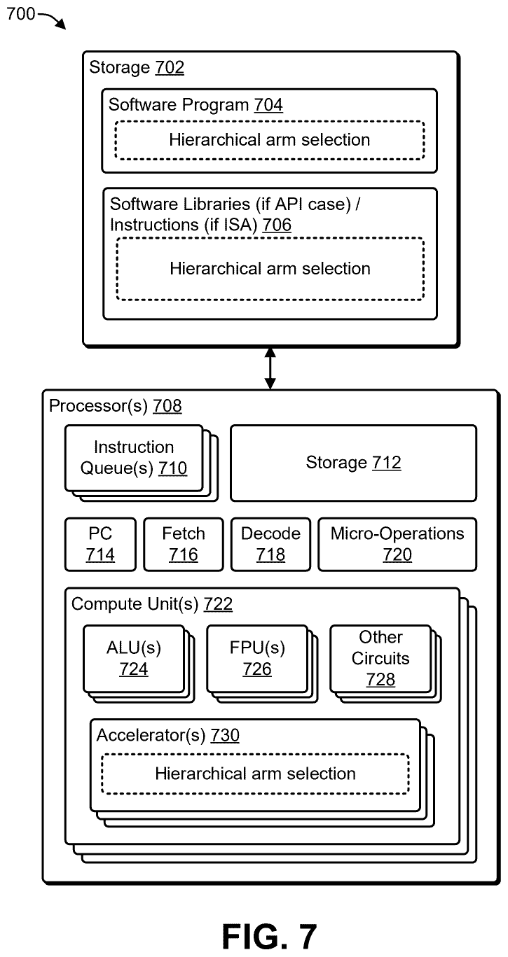

FIG. 6 illustrates an example of a system 600 that includes one or more drivers and/or one or more runtimes (illustrated as reference numeral 604) including one or more libraries 606 to provide one or more application programming interfaces (“API(s)”) 610, in accordance with at least one embodiment. In at least one embodiment, the system 600 includes the driver(s) 604 and/or the runtime(s) 604 including the library(ies) 606 to provide to the API(s) 610. In at least one embodiment, the API(s) 610 is/are sets of software instructions that, if executed, cause one or more processors (e.g., processor(s) 708 illustrated in FIG. 7) to perform one or more computational operations. In at least one embodiment, one or more of the API(s) 610 is/are distributed or otherwise provided as a part of one or more of the library(ies) 606, one or more of the runtime(s) 604, one or more of the driver(s) 604, and/or one or more component of any other grouping of software and/or executable code further described herein. In at least one embodiment, one or more of the API(s) 610 perform one or more computational operations in response to invocation by one or more software programs 602.

In at least one embodiment, one or more of the software program(s) 602 is/are a software module and/or include(s) one or more software modules. In at least one embodiment, a software module is as further illustrated non-exclusively in FIG. 7 as a software program 704 (or component thereof) and described with respect thereto. In at least one embodiment, one or more of the software program(s) 602 is/are a collection of software code, commands, instructions, and/or other sequences of text to instruct a computing device (e.g., DPU 114) to perform one or more computational operations and/or invoke one or more other sets of instructions, such as the API(s) 610 or API function(s) 612, to be executed by the computing device. In at least one embodiment, the functions 612 select one or more device parameters based, at least in part, on generating one or more clusters of possible values of the one or more device parameters, and selecting one or more of the clusters, and/or otherwise perform any of the operations described herein. In at least one embodiment, functionality provided by one or more of the API(s) 610 includes the API function(s) 612, such as those usable to accelerate one or more portions of the software program(s) 602 using one or more parallel processing units (PPUs), such as graphics processing units (GPUs).

In at least one embodiment, one or more of the API(s) 610 is/are one or more hardware interfaces to one or more circuits to perform one or more computational operations. In at least one embodiment, one or more of the API(s) 610 described herein are implemented as one or more circuits to perform one or more techniques described in connection with FIGS. 1-5. In at least one embodiment, one or more of the software program(s) 602 include instructions that, if executed, cause one or more hardware devices and/or circuits to perform one or more techniques further described in connection with FIGS. 1-5. In at least one embodiment, the system 600 includes one or more or all components of the datacenter 100 and/or framework 200 described in relation to FIGS. 1-5, and the system 600 may perform one or more or all of the processes and/or operations that the systems and components of the datacenter 100 and/or framework 200 perform.

In at least one embodiment, the software program(s) 602, such as user-implemented software programs, utilize one or more of the API(s) 610 to perform various computing operations, such as memory reservation, matrix multiplication, arithmetic operations, and/or any computing operation performed by PPUs, such as GPUs, as further described herein. In at least one embodiment, the function(s) 612 include a set of callable functions provided by one or more of the API(s) 610 that are referred to herein as APIs, API functions, software functions, and/or functions, that individually perform one or more computing operations, such as computing operations related to parallel computing. In at least one embodiment, one or more of the API(s) 610 perform generation and/or selection of clusters and/or parameter values, and/or perform other operations described herein (e.g., in connection with FIGS. 1-5).

In at least one embodiment, one or more of the software program(s) 602 interact or otherwise communicate with one or more of the API(s) 610 to perform one or more computing operations using one or more processors (e.g., processor(s) 708 illustrated in FIG. 7), such as one or more PPUs, such as GPUs. In at least one embodiment, one or more computing operations using one or more PPUs include at least one or more groups of computing operations to be accelerated by execution at least in part by said one or more PPUs. In at least one embodiment, one or more of the software program(s) 602 interact with one or more of the API(s) 610 to generation and/or selection of clusters and/or parameter values, and/or perform other operations described herein (e.g., in connection with FIGS. 1-5).

In at least one embodiment, an interface is software instructions that, if executed, provide access to one or more of the function(s) 612 provided by one or more of the API(s) 610. In at least one embodiment, one or more of the software program(s) 602 use(s) a local interface when a software developer compiles one or more of the software program(s) 602 in conjunction with one or more of the library(ies) 606 including or otherwise providing access to one or more of the API(s) 610. In at least one embodiment, one or more of the software program(s) 602 is/are compiled statically in conjunction with one or more pre-compiled ones of the library(ies) 606 and/or uncompiled source code including instructions to perform one or more of the API(s) 610. In at least one embodiment, one or more of the software program(s) 602 are compiled dynamically and the dynamically compiled software program(s) utilize a linker to link to one or more pre-compiled ones of the library(ies) 606, including one or more of the API(s) 610.

In at least one embodiment, one or more of the software program(s) 602 use(s) a remote interface when a software developer executes a software program that utilizes or otherwise communicates with at least one of the library(ies) 606 including one or more of the API(s) 610 over a network or other remote communication medium. In at least one embodiment, one or more of the library(ies) 606 including one or more of the API(s) 610 are to be performed by a remote computing service, such as a computing resource services provider. In at least one embodiment, one or more of the library(ies) 606 including one or more particular APIs (of the API(s) 610) is/are to be performed by any other computing host providing the particular API(s) to one or more of the software program(s) 602.

In at least one embodiment, a processor (e.g., processor(s) 708 illustrated in FIG. 7) performing or using one or more particular ones of the software program(s) 602 calls, uses, performs, and/or otherwise implements one or more of the API(s) 610 to allocate and otherwise manage memory 614 to be used by the particular software program(s). In at least one embodiment, one or more particular ones of the software program(s) 602 utilize one or more of the API(s) 610 to allocate and otherwise manage the memory 614 to be used by one or more portions of the particular software program(s) to be accelerated using one or more PPUs, such as GPUs, or any other accelerator or processor further described herein. In at least one embodiment, one or more of the software program(s) 602 request one or more neural networks to perform signal processing using one or more of the function(s) 612 provided by one or more of the API(s) 610. In at least one embodiment, memory 112 implements memory 614.

In at least one embodiment, one or more of the API(s) 610 is an API to facilitate parallel computing. In at least one embodiment, one or more of the API(s) 610 is any other API further described herein. In at least one embodiment, one or more of the API(s) 610 is/are provided by one or more of the driver(s) 604 and/or one or more of the runtime(s) 604. In at least one embodiment, one or more of the API(s) 610 is/are provided by a CUDA user-mode driver. In at least one embodiment, one or more of the API(s) 610 is/are provided by a CUDA runtime. In at least one embodiment, one or more of the driver(s) 604 is/are data values and software instructions that, if executed, perform and/or otherwise facilitate operation of one or more of the function(s) 612 of one or more of the API(s) 610 during load and execution of one or more portions of at least one of the software program(s) 602. In at least one embodiment, one or more of the runtime(s) 604 is/are data values and/or software instructions that, if executed, perform or otherwise facilitate operation of one or more of the function(s) 612 of one or more of the API(s) 610 during execution of at least one of the software program(s) 602. In at least one embodiment, one or more particular ones of the software program(s) 602 utilize one or more of the API(s) 610 implemented and/or otherwise provided by one or more of the driver(s) 604 and/or one or more of the runtime(s) 604 to perform combined arithmetic operations by the particular software program(s) during execution by one or more PPUs, such as GPUs.

In at least one embodiment, one or more of the software program(s) 602 utilize one or more of the API(s) 610 provided by one or more of the driver(s) 604 and/or one or more of the runtime(s) 604 to perform combined arithmetic operations of one or more PPUs, such as GPUs. In at least one embodiment, one or more of the API(s) 610 provide combined arithmetic operations through one or more of the driver(s) 604 and/or one or more of the runtime(s) 604, as described above. In at least one embodiment, one or more of the software program(s) 602 utilize one or more of the API(s) 610 provided by one or more of the driver(s) 604 and/or one or more of the runtime(s) 604 to allocate or otherwise reserve one or more blocks of the memory 614 of one or more PPUs, such as GPUs. In at least one embodiment, one or more of the software program(s) 602 utilize one or more of the API(s) 610 provided by one or more of the driver(s) 604 and/or one or more of the runtime(s) 604 to allocate or otherwise reserve blocks of the memory 614.

In at least one embodiment, to improve usability of one or more particular ones of the software program(s) 602 and/or improve performance, one or more portions of the particular software programs are to be accelerated by one or more PPUs (such as GPUs). In at least one embodiment, one or more of the function(s) 612 receive one or more input parameters indicating one or more inputs to one or more neural networks and/or other data to be utilized by the neural network(s), such as one or more hyperparameters of the neural network(s). In at least one embodiment, the input parameter(s) include the one or more inputs and/or the other data. In at least one embodiment, the input parameter(s) include one or more pointers to one or more memory locations where the input(s) and/or the other data is/are stored.

In at least one embodiment, the system 600 includes at least one processor (e.g., processor(s) 708 illustrated in FIG. 7) including one or more circuits to perform one or more software programs to combine two or more of the API(s) 610 into a single API. In at least one embodiment, the system 600 includes at least one processor (e.g., processor(s) 708 illustrated in FIG. 7) that uses one or more of the API(s) 610 to perform generation and/or selection of clusters and/or parameter values, and/or otherwise perform operations described herein. In at least one embodiment, the system 600 includes at least one processor (e.g., processor(s) 708 illustrated in FIG. 7) that uses one or more of the API(s) 610 to perform one or more operations illustrated in and/or described with respect to one or more of FIGS. 1-5, such as one or more processes illustrated in FIGS. 1-5 or portion(s) thereof. In at least one embodiment, the system 600 includes at least one processor (e.g., processor(s) 708 illustrated in FIG. 7) to perform one or more of the function(s) 612, such as those described in connection with FIGS. 1-5. In at least one embodiment, one or more of the API(s) 610 is to be performed by hardware described in connection with FIGS. 7-10.

FIG. 7 illustrates an example of a system 700 that can include software and hardware to perform generation and/or selection of clusters and/or parameter values or otherwise perform any of the operations described herein, according to at least one embodiment. System 700 can include storage 702 and processor(s) 708. Storage 702 can include, for example, memory, cache, or other storage described further herein. Storage 702 can be separate from processor(s) 708, or storage 702 can be included in processor(s) 708 (e.g., in storage 712). In at least one embodiment, software program 704 and/or software libraries (or instructions) 706 can be stored in memory, cache, or other storage and provided to processor(s) 708 to cause one or more circuits of processor(s) 708 to perform operations described herein. In at least one embodiment, software program 704 and/or software libraries (or instructions) 706 can be integrated into one or more circuits of processor(s) 708. Software program 704, which can be used to perform any of the operations described herein, may be stored on storage 702.

In at least one embodiment, software program 704 can include one or more software modules, e.g., a clustering module, a cluster selection module, an arm selection module, and/or a weight updating module.

In at least one embodiment, as used in any implementation described herein, unless otherwise clear from context or stated explicitly to contrary, a module refers to any combination of software logic, firmware logic, hardware logic, and/or circuitry configured to provide functionality described herein. In at least one embodiment, software is embodied as a software package, code and/or instruction set or instructions, and “hardware,” as used in any implementation described herein, includes, for example, singly or in any combination, hardwired circuitry, programmable circuitry, state machine circuitry, fixed function circuitry, execution unit circuitry, and/or firmware that stores instructions performed by programmable circuitry. In at least one embodiment, modules are, collectively or individually, embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof including those further described herein.

In at least one embodiment, software program 704 can include a collection of software code, commands, instructions, or other sequences of text to instruct a computing device to perform one or more computational operations and/or invoke one or more other sets of instructions, such as API(s) or API function(s) or Instruction Set Architecture (ISA) level instructions, to be executed or otherwise performed. Instructions (e.g., hardware instructions) or microcode can involve ISA level instructions, which can include native ISA instructions or non-native ISA instructions. Software program 704 and/or software libraries (or instructions) 706 (e.g., one or more modules) can be distributed among multiple processors that communicate over a bus, network, by writing to shared memory, and/or any suitable communication process such as those described herein.

In at least one embodiment, system 700 can include one or more software libraries 706 that can, for example, provide one or more APIs and/or ISA instructions. In at least one embodiment, one or more APIs and/or ISA instructions can be used to perform generation and/or selection of clusters and/or parameter values. In at least one embodiment, one or more software libraries 706 can be included in drivers and/or runtimes. In at least one embodiment, software libraries 706 (e.g., including one or more APIs and/or ISA instructions) can include sets of software instructions that, if executed or otherwise performed, cause processor(s) 708 to perform one or more computational operations, such as any of the operations described herein. In at least one embodiment, one or more APIs and/or ISA instructions can be distributed or otherwise provided as a part of one or more software libraries 706, runtimes, drivers, and/or any other grouping of software and/or executable code further described herein. In at least one embodiment, one or more APIs and/or ISA instructions can perform one or more computational operations in response to invocation by software program 704.

Processor(s) 708 may include any number of processors and any suitable processing unit and/or combination of processing units, such as, but not limited to, central processing units (“CPUs”), graphics processing units (“GPUs”), or other processors (including accelerators, field programmable gate arrays (FPGAs), graphics processors, parallel processors, GPGPUs, DPUs, and/or variations thereof including those further described herein), including any processors described herein, such as, but not limited to, processors in FIGS. 7-19. In at least one embodiment, processor(s) 708 can retrieve or fetch instructions (e.g., one or more APIs and/or ISA instructions) from storage 702 using, for example, instruction fetch 716 (e.g., for an Instruction Fetch stage). Instructions can include instructions to perform generation and/or selection of clusters and/or parameter values. In at least one embodiment, processor(s) 708 can include storage 712 and instruction queue 710 to store and queue instructions fetched from storage 702. In at least one embodiment, fetched instructions can be decoded by decode 718 to determine what operation should be performed by processor(s) 708 (e.g., in an Instruction Decode stage). In at least one embodiment, processor(s) 708 can fetch additional operands (data) that may be used for instructions, and operands can be stored, e.g., in registers or storage 712. In at least one embodiment, micro-operations 720 can perform operations on data stored in one or more registers or storage 712. For example, each step of instructions fetched by processor(s) 708 can be decomposed during execution so processor(s) 708 can execute instructions in steps through a series of micro-operations 720. In at least one embodiment, program counter (PC) 714 can hold an address for a next instruction and can be updated to point to the next instruction to be executed by processor(s) 708.

In at least one embodiment, processor(s) 708 can perform instructions (e.g., in an Execution stage). For example, processor(s) 708 can perform an operation specified by the instructions, such as an arithmetic operation, a logical operation, or a data transfer. In at least one embodiment, compute unit(s) 722 can execute instructions to perform any of the operations described herein. In at least one embodiment, compute unit(s) can include ALU(s) 724 (Arithmetic Logic Units), which may be used for performing arithmetic and logical operations. In at least one embodiment, compute unit(s) can include FPU(s) (Floating Point Units) 726, which may be used for performing floating-point calculations. In at least one embodiment, other circuits 728 can be used to perform other operations, such as vector and/or scalar operations. In at least one embodiment, accelerator(s) 730 can include one or more matrix multiplication accelerators, one or more parallel processing units (PPUs), such as GPUs, or any other accelerator or processor further described herein. In at least one embodiment, software program 704 can utilize one or more APIs and/or ISA instructions to perform various computing operations with accelerator(s) 730, such as matrix multiplication, arithmetic operations, or any other computing operation further described herein. In at least one embodiment, one or more computing operations using accelerator(s) 730 can include at least one or more groups of computing operations to be accelerated by execution at least in part by accelerator(s) 730, including to perform generation and/or selection of clusters and/or parameter values.

In at least one embodiment, system 700 can be used to perform one or more instructions that include functions or operations, such as those described in connection with FIGS. 1-5. In at least one embodiment, system 700 comprising one or more processors causes one or more circuits to perform generation and/or selection of clusters and/or parameter values and/or otherwise perform operations described herein. In at least one embodiment, system 700 is included in and/or otherwise includes systems illustrated in FIGS. 1-5 to cause one or more circuits to perform generation and/or selection of clusters and/or parameter values and/or otherwise perform operations described herein. In at least one embodiment, system 700 includes one or more hardware illustrated in FIGS. 1-5, such as to perform generation and/or selection of clusters and/or parameter values and/or otherwise perform operations described herein.

### Logic

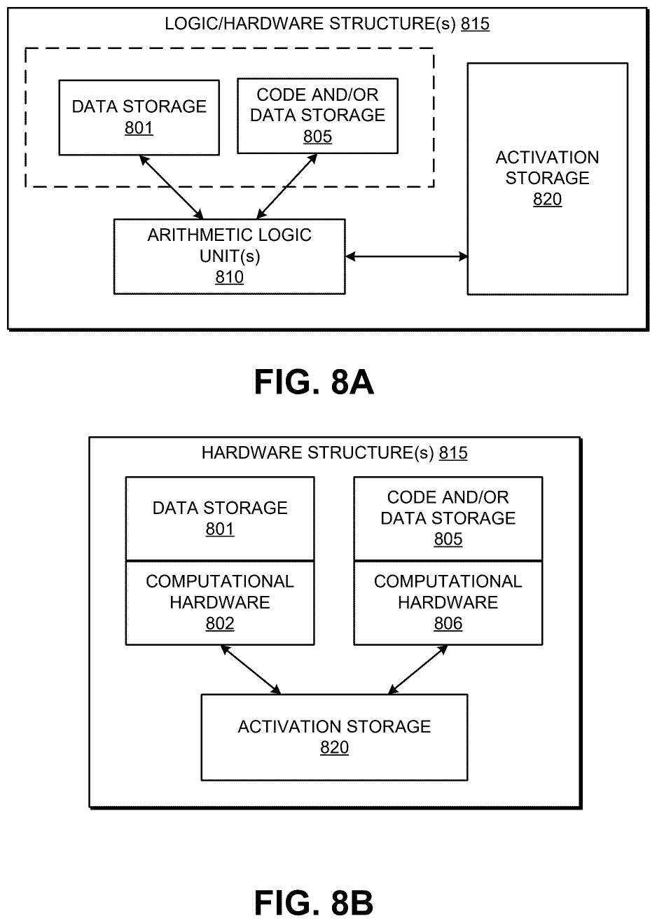

FIG. 8A illustrates logic 815 which, as described elsewhere herein, can be used in one or more devices to perform operations such as those discussed herein in accordance with at least one embodiment. In at least one embodiment, logic 815 is used to perform inferencing and/or training operations associated with one or more embodiments. In at least one embodiment, logic 815 is inference and/or training logic. Details regarding logic 815 are provided below in conjunction with FIGS. 8A and/or 8B. In at least one embodiment, logic refers to any combination of software logic, hardware logic, and/or firmware logic to provide functionality or operations described herein, wherein logic may be, collectively or individually, embodied as circuitry that forms part of a larger system, for example, an integrated circuit (IC), system-on-chip (SoC), or one or processors (e.g., CPU, GPU).

In at least one embodiment, logic 815 may include, without limitation, code and/or data storage 801 to store forward and/or output weight and/or input/output data, and/or other parameters to configure neurons or layers of a neural network trained and/or used for inferencing in aspects of one or more embodiments. In at least one embodiment, logic 815 may include, or be coupled to code and/or data storage 801 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 801 may be included with other on-chip or off-chip data storage, including a processor's L1, L2, or L3 cache or system memory.

In at least one embodiment, any portion of code and/or data storage 801 may be internal or external to one or more processors or other hardware logic devices or circuits. In at least one embodiment, code and/or code and/or data storage 801 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 801 is internal or external to a processor, for example, or including DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, logic 815 may include, without limitation, a code and/or data storage 805 to store backward and/or output weight and/or input/output data corresponding to neurons or layers of a neural network trained and/or used for inferencing in aspects of one or more embodiments. In at least one embodiment, code and/or data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, logic 815 may include, or be coupled to code and/or data storage 805 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 805 may be included with other on-chip or off-chip data storage, including a processor's L1, L2, or L3 cache or system memory. In at least one embodiment, any portion of code and/or data storage 805 may be internal or external to one or more processors or other hardware logic devices or circuits. In at least one embodiment, code and/or data storage 805 may be cache memory, DRAM, SRAM, non-volatile memory (e.g., flash memory), or other storage. In at least one embodiment, a choice of whether code and/or data storage 805 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 801 and code and/or data storage 805 may be separate storage structures. In at least one embodiment, code and/or data storage 801 and code and/or data storage 805 may be a combined storage structure. In at least one embodiment, code and/or data storage 801 and code and/or data storage 805 may be partially combined and partially separate. In at least one embodiment, any portion of code and/or data storage 801 and code and/or data storage 805 may be included with other on-chip or off-chip data storage, including a processor's L1, L2, or L3 cache or system memory.

In at least one embodiment, logic 815 may include, without limitation, one or more arithmetic logic unit(s) (“ALU(s)”) 810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 820 that are functions of input/output and/or weight parameter data stored in code and/or data storage 801 and/or code and/or data storage 805. In at least one embodiment, activations stored in activation storage 820 are generated according to linear algebraic and or matrix-based mathematics performed by ALU(s) 810 in response to performing instructions or other code, wherein weight values stored in code and/or data storage 805 and/or data storage 801 are used as operands along with other values, such as bias values, gradient information, momentum values, or other parameters or hyperparameters, any or all of which may be stored in code and/or data storage 805 or code and/or data storage 801 or another storage on or off-chip.

In at least one embodiment, ALU(s) 810 are included within one or more processors or other hardware logic devices or circuits, whereas in another embodiment, ALU(s) 810 may be external to a processor or other hardware logic device or circuit that uses them (e.g., a coprocessor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 801, code and/or data storage 805, and activation storage 820 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., flash memory), or other storage. In at least one embodiment, activation storage 820 may be completely or partially within or external to one or more processors or other logical circuits. In at least one embodiment, a choice of whether activation storage 820 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, logic 815 illustrated in FIG. 8A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, logic 815 illustrated in FIG. 8A may be used in conjunction with central processing unit (“CPU”) hardware, graphics processing unit (“GPU”) hardware or other hardware, such as field programmable gate arrays (“FPGAs”).

FIG. 8B illustrates logic 815, according to at least one embodiment. In at least one embodiment, logic 815 is inference and/or training logic. In at least one embodiment, logic 815 may include, without limitation, hardware logic in which computational resources are dedicated or otherwise exclusively used in conjunction with weight values or other information corresponding to one or more layers of neurons within a neural network. In at least one embodiment, logic 815 illustrated in FIG. 8B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, logic 815 illustrated in FIG. 8B may be used in conjunction with central processing unit (CPU) hardware, graphics processing unit (GPU) hardware or other hardware, such as field programmable gate arrays (FPGAs). In at least one embodiment, logic 815 includes, without limitation, code and/or data storage 801 and code and/or data storage 805, which may be used to store code (e.g., graph code), weight values and/or other information, including bias values, gradient information, momentum values, and/or other parameter or hyperparameter information. In at least one embodiment illustrated in FIG. 8B, each of code and/or data storage 801 and code and/or data storage 805 is associated with a dedicated computational resource, such as computational hardware 802 and computational hardware 806, respectively. In at least one embodiment, each of computational hardware 802 and computational hardware 806 includes one or more ALUs that perform mathematical functions, such as linear algebraic functions, only on information stored in code and/or data storage 801 and code and/or data storage 805, respectively, result of which is stored in activation storage 820.

In at least one embodiment, each of code and/or data storage 801 and 805 and corresponding computational hardware 802 and 806, respectively, correspond to different layers of a neural network, such that resulting activation from one storage/computational pair 801/802 of code and/or data storage 801 and computational hardware 802 is provided as an input to a next storage/computational pair 805/806 of code and/or data storage 805 and computational hardware 806, in order to mirror a conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage/computation pairs 801/802 and 805/806 may be included in logic 815.

### Data Center

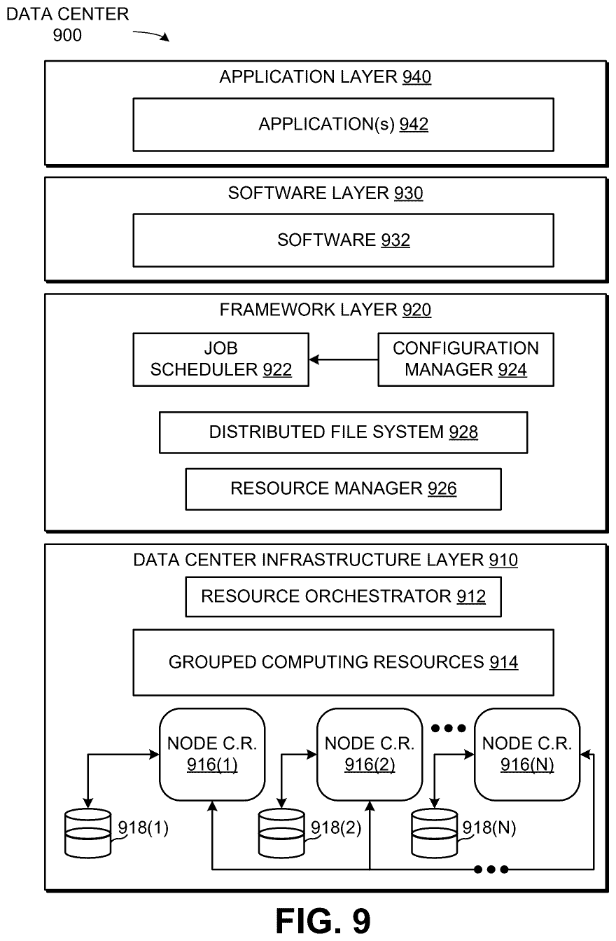

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents a positive integer (which may be a different integer “N” than used in other figures). In at least one embodiment, node C.R.s 916(1)-916(N) may include, but are not limited to, any number of central processing units (“CPUs”) or other processors (including accelerators, field programmable gate arrays (FPGAs), graphics processors, etc.), memory storage devices 918(1)-918(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). In at least one embodiment, separate groupings of node C.R.s within grouped computing resources 914 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-916(N) and/or grouped computing resources 914. In at least one embodiment, resource orchestrator 912 may include a software design infrastructure (“SDI”) management entity for data center 900. In at least one embodiment, resource orchestrator 912 may include hardware, software or some combination thereof.

In at least one embodiment, as shown in FIG. 9, framework layer 920 includes a job scheduler 922, a configuration manager 924, a resource manager 926 and a distributed file system 928. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 928 for large-scale data processing (e.g., “big data”). In at least one embodiment, job scheduler 922 may include a Spark driver to facilitate scheduling of workloads supported by various layers of data center 900. In at least one embodiment, configuration manager 924 may be capable of configuring different layers such as software layer 930 and framework layer 920 including Spark and distributed file system 928 for supporting large-scale data processing. In at least one embodiment, resource manager 926 may be capable of managing clustered or grouped computing resources mapped to or allocated for support of distributed file system 928 and job scheduler 922. In at least one embodiment, clustered or grouped computing resources may include grouped computing resources 914 at data center infrastructure layer 910. In at least one embodiment, resource manager 926 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 928 of framework layer 920. In at least one embodiment, one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 928 of framework layer 920. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 924, resource manager 926, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Logic 815 are used to perform inferencing and/or training operations associated with one or more embodiments. Details regarding logic 815 are provided herein in conjunction with FIGS. 8A and/or 8B. In at least one embodiment, logic 815 may be used in data center 900 for inferencing or predicting operations based, at least in part, on weight parameters calculated using neural network training operations, neural network functions and/or architectures, or neural network use cases described herein.

### Computer Systems

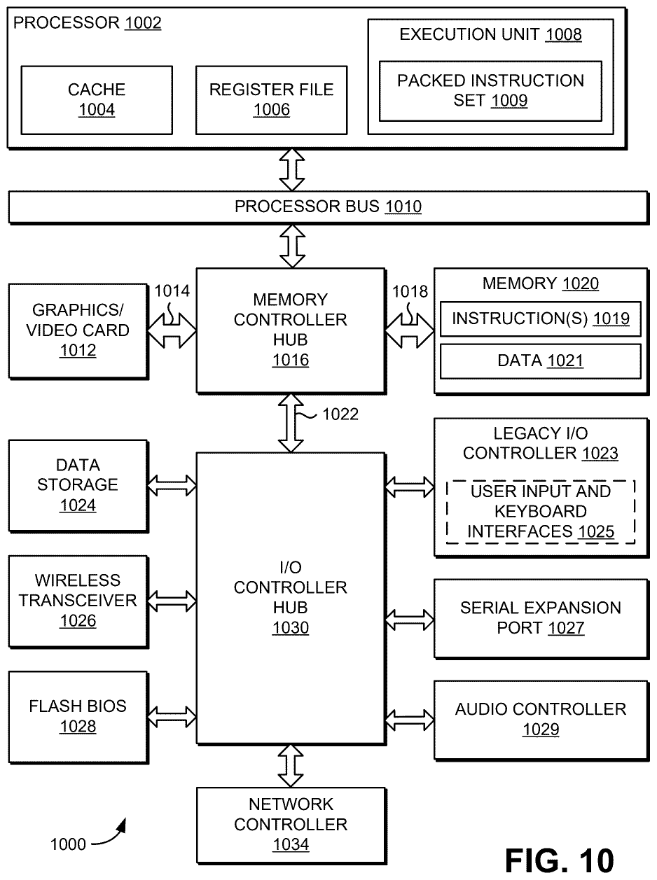

FIG. 10 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 1000 may include, without limitation, a component, such as a processor 1002 to employ execution units including logic to perform algorithms for process data, in accordance with present disclosure, such as in embodiment described herein. In at least one embodiment, computer system 1000 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1000 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 1000 may include, without limitation, processor 1002 that may include, without limitation, one or more execution units 1008 to perform machine learning model training and/or inferencing according to techniques described herein. In at least one embodiment, computer system 1000 is a single processor desktop or server system, but in another embodiment, computer system 1000 may be a multiprocessor system. In at least one embodiment, processor 1002 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 1002 may be coupled to a processor bus 1010 that may transmit data signals between processor 1002 and other components in computer system 1000.

In at least one embodiment, processor 1002 may include, without limitation, a Level 1 (“L1”) internal cache memory (“cache”) 1004. In at least one embodiment, processor 1002 may have a single internal cache or multiple levels of internal cache. In at least one embodiment, cache memory may reside external to processor 1002. Other embodiments may also include a combination of both internal and external caches depending on particular implementation and needs. In at least one embodiment, a register file 1006 may store different types of data in various registers including, without limitation, integer registers, floating point registers, status registers, and an instruction pointer register.

In at least one embodiment, execution unit 1008, including, without limitation, logic to perform integer and floating point operations, also resides in processor 1002. In at least one embodiment, processor 1002 may also include a microcode (“ucode”) read only memory (“ROM”) that stores microcode for certain macro instructions. In at least one embodiment, execution unit 1008 may include logic to handle a packed instruction set 1009. In at least one embodiment, by including packed instruction set 1009 in an instruction set of a general-purpose processor, along with associated circuitry to execute instructions, operations used by many multimedia applications may be performed using packed data in processor 1002. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 1008 may also be used in microcontrollers, embedded processors, graphics devices, DSPs, and other types of logic circuits. In at least one embodiment, computer system 1000 may include, without limitation, a memory 1020. In at least one embodiment, memory 1020 may be a Dynamic Random Access Memory (“DRAM”) device, a Static Random Access Memory (“SRAM”) device, a flash memory device, or another memory device. In at least one embodiment, memory 1020 may store instruction(s) 1019 and/or data 1021 represented by data signals that may be executed by processor 1002.

In at least one embodiment, a system logic chip may be coupled to processor bus 1010 and memory 1020. In at least one embodiment, a system logic chip may include, without limitation, a memory controller hub (“MCH”) 1016, and processor 1002 may communicate with MCH 1016 via processor bus 1010. In at least one embodiment, MCH 1016 may provide a high bandwidth memory path 1018 to memory 1020 for instruction and data storage and for storage of graphics commands, data and textures. In at least one embodiment, MCH 1016 may direct data signals between processor 1002, memory 1020, and other components in computer system 1000 and to bridge data signals between processor bus 1010, memory 1020, and a system I/O interface 1022. In at least one embodiment, a system logic chip may provide a graphics port for coupling to a graphics controller. In at least one embodiment, MCH 1016 may be coupled to memory 1020 through high bandwidth memory path 1018 and a graphics/video card 1012 may be coupled to MCH 1016 through an Accelerated Graphics Port (“AGP”) interconnect 1014.

In at least one embodiment, computer system 1000 may use system I/O interface 1022 as a proprietary hub interface bus to couple MCH 1016 to an I/O controller hub (“ICH”) 1030. In at least one embodiment, ICH 1030 may provide direct connections to some I/O devices via a local I/O bus. In at least one embodiment, a local I/O bus may include, without limitation, a high-speed I/O bus for connecting peripherals to memory 1020, a chipset, and processor 1002. Examples may include, without limitation, an audio controller 1029, a firmware hub (“flash BIOS”) 1028, a wireless transceiver 1026, a data storage 1024, a legacy I/O controller 1023 containing user input and keyboard interfaces 1025, a serial expansion port 1027, such as a Universal Serial Bus (“USB”) port, and a network controller 1034. In at least one embodiment, data storage 1024 may include a hard disk drive, a floppy disk drive, a CD-ROM device, a flash memory device, or other mass storage device.

In at least one embodiment, FIG. 10 illustrates a system, which includes interconnected hardware devices or “chips”, whereas in other embodiments, FIG. 10 may illustrate an exemplary SoC. In at least one embodiment, devices illustrated in FIG. 10 may be interconnected with proprietary interconnects, standardized interconnects (e.g., PCIe) or some combination thereof. In at least one embodiment, one or more components of computer system 1000 are interconnected using compute express link (CXL) interconnects.

Logic 815 are used to perform inferencing and/or training operations associated with one or more embodiments. Details regarding logic 815 are provided herein in conjunction with FIGS. 8A and/or 8B. In at least one embodiment, logic 815 may be used in computer system 1000 for inferencing or predicting operations based, at least in part, on weight parameters calculated using neural network training operations, neural network functions and/or architectures, or neural network use cases described herein.

At least one embodiment of the disclosure can be described in view of the following clauses:
1. A processor, comprising: one or more circuits to select one or more device parameters based, at least in part, on: generating one or more clusters of possible values of the one or more device parameters, and selecting one or more of the clusters.
2. The processor of clause 1, wherein the one or more circuits are further to select the one or more device parameters from among the one or more selected clusters.
3. The processor of clause 1 or 2, wherein the one or more circuits are to use a multi-armed bandit algorithm to select the one or more selected clusters.
4. The processor of any of cluses 1-3, wherein the one or more device parameters are to be elected based, at least in part, on an EXP3 algorithm.
5. The processor of any of clauses 1-4, wherein the generating of the one of more clusters is to be performed based, at least in part, on a k-means algorithm.
6. The processor of any of clauses 1-5, wherein the one or more clusters adhere to a Lipschitz condition.
7. The processor of any of clauses 1-6, wherein the one or more device parameters are parameters of one or more storage devices.
8. A method, comprising: generating clusters of possible values of device parameters; selecting one or more of the clusters based, at least in part, on a predicted outcome of the selection of the one or more clusters; selecting one or more of the possible values from among the selected one or more clusters based, at least in part, on a predicted outcome of the selection of the one or more possible values.
9. The method of clause 8, wherein generating the clusters of possible values of device parameters is performed such that similar values of device parameters are to be included in a same cluster.
10. The method of clause 8 or 9, further comprising observing an actual outcome of selecting the one or more clusters.
11. The method of any of clauses 8-10, further comprising observing an actual outcome of selecting the one or more possible values.
12. The method of any of clauses 8-11, further comprising updating the predicted outcome of the selection of the one or more clusters.
13. The method of any of clauses 8-12, further comprising updating the predicted outcome of the selection of the one or more clusters.
14. The method of any of clauses 8-13, wherein the selection of the one or more clusters and the selection of the one or more possible values is to be performed based, at least in part, on an EXP3 algorithm.
15. A system, comprising: one or more storage devices; and one or more data processing units (DPUs) comprising one or more circuits to: generate clusters of possible storage device parameters; and select one or more of the possible storage device parameters from among one or more of the clusters.
16. The system of clause 15, wherein the one or more DPUs are further to configure the one or more storage devices according to the one or more selected parameters.
17. The system of clause 15 or 16, wherein the one or more DPUs are further to select one or more clusters from which the one or more of the possible storage device parameters are to be selected.
18. The system of any of clauses 15-17, wherein the selection of the one or more of the possible storage device parameters is based, at least in part, on a predicted outcome of configuring the one or more storage devices according to the one or more selected parameters.
19. The system of any of clauses 15-18, wherein a selection of the one or more clusters is based, at least in part, on a predicted outcome of configuring the one or more storage devices according to the one or more selected parameters.
20. The system of any of clauses 15-19, wherein the one or more DPUs are further to select one or more of the clusters from which to select the one or more of the possible storage device parameters.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, computer programs in form of machine-readable executable code or computer control logic algorithms are stored in main memory and/or secondary storage such as those described herein. Computer programs, if executed by one or more processors, enable at least one system described herein to perform various functions in accordance with at least one embodiment. In at least one embodiment, memory, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of a CPU such as those described herein, a parallel processing system such as those described herein, an integrated circuit capable of at least a portion of capabilities of both the CPU, the parallel processing system, a chipset (e.g., a group of integrated circuits designed to work and sold as a unit for performing related functions, etc.), and/or any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, a computer system described herein may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic. In at least one embodiment, a computer system includes or refers to any devices illustrated in any of the drawings and/or described herein.

In at least one embodiment, a parallel processing system includes, without limitation, a plurality of parallel processing units (“PPUs”) and associated memories. In at least one embodiment, PPUs are connected to a host processor or other peripheral devices via an interconnect and a switch or multiplexer. In at least one embodiment, a parallel processing system distributes computational tasks across the PPUs, which can be parallelizable—for example, as part of distribution of computational tasks across multiple graphics processing unit (“GPU”) thread blocks. In at least one embodiment, memory is shared and accessible (e.g., for read and/or write access) across some or all of the PPUs, although such shared memory may incur performance penalties relative to use of local memory and registers resident to a PPU. In at least one embodiment, operation of the PPUs is synchronized through use of a command such as _syncthreads( ), wherein all threads in a block (e.g., executed across multiple PPUs) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, one VPL implements various functions for media pipelines on CPUs, GPUs, and other accelerators. In at least one embodiment, one VPL implements device discovery and selection in media centric and video analytics workloads. In at least one embodiment, one VPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation includes generating one or more machine-executable instructions, operations, or other signals from source code. In at least one embodiment, an API compiled into one or more instructions, operations, or other signals, when performed, causes one or more processors, such as graphics processors, graphics cores, parallel processor, a CPU, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, comprising:
one or more circuits to select one or more device parameters based, at least in part, on:
generating clusters of possible values of the one or more device parameters,
selecting one or more of the clusters; and
causing at least one device to be configured based at least in part on the one or more selected clusters.

2. The processor of claim 1, wherein the one or more circuits are further to:
select the one or more device parameters from among the one or more selected clusters.

3. The processor of claim 1, wherein the one or more circuits are to use a multi-armed bandit algorithm to select the one or more selected clusters.

4. The processor of claim 1, wherein the one or more circuits are to use an EXP3 algorithm to select the one or more device parameters.

5. The processor of claim 1, wherein the one or more circuits are to use a k-means algorithm to generate the clusters.

6. The processor of claim 1, wherein the clusters adhere to a Lipschitz condition.

7. The processor of claim 1, wherein the one or more device parameters are parameters of one or more storage devices, and the at least one device comprises at least one of the one or more storage devices.

8. A method, comprising:
generating clusters of different sets of values of device parameters;
selecting one or more of the clusters based, at least in part, on a predicted outcome associated with the selection of the one or more clusters; and
selecting one or more of the different sets of values from among the selected one or more clusters based, at least in part, on a predicted outcome associated with the selection of the one or more possible values.

9. The method of claim 8, wherein generating the clusters of different sets of values of device parameters is performed such that two or more of the different sets of values of device parameters including similar values of device parameters are to be included in a same cluster.

10. The method of claim 8, further comprising:
calculating a reward associated with selecting the one or more clusters.

11. The method of claim 8, further comprising:
observing an actual outcome of configurating at least one device using the one or more different sets of values.

12. The method of claim 8, further comprising:
updating the predicted outcome of the selection of the one or more clusters.

13. The method of claim 8, wherein the selection of the one or more clusters and the selection of the one or more different sets of values is to be performed based, at least in part, on an EXP3 algorithm.

14. A system, comprising:
one or more storage devices; and
one or more data processing units (DPUs) comprising one or more circuits to:
generate clusters of sets of storage device parameter values; and
select one or more of the sets of storage device parameter values from among one or more of the clusters.

15. The system of claim 14, wherein the one or more DPUs are further to configure the one or more storage devices according to the one or more selected sets of storage device parameter values.

16. The system of claim 14, wherein the selection of the one or more selected sets of storage device parameter values is based, at least in part, on a predicted outcome of configuring the one or more storage devices according to the one or more selected sets of storage device parameter values.

17. The system of claim 14, wherein the one or more DPUs are further to select one or more clusters from which the one or more selected sets of storage device parameter values are to be selected.

18. The system of claim 17, wherein the selection of the one or more clusters is to be based, at least in part, on a predicted outcome of configuring the one or more storage devices according to the one or more selected sets of storage device parameter values.

19. The system of claim 14, wherein the one or more DPUs are further to measure one or more results of configuring the one or more storage devices according to the one or more selected sets of storage device parameter values.

20. The system of claim 14, wherein the one or more DPUs are further to update one or more weights associated with the selected sets of storage device parameter values.
